(19) United States
(12) Patent Application Publication
(10) Pub. No.: US 2026/0318879 A1
(43) Pub. Date: Oct. 15, 2026

(54) WEAR SENSING AND WEAR SENSOR

(71) Applicant: LUXEMBOURG INSTITUTE OF SCIENCE AND TECHNOLOGY (LIST), Eschsur- Alzette (LU)

(72) Inventor: Jérôme POLESEL, MEXY (FR)

(21) Appl. No.: 19/111,992

(22) PCT Filed: Sep. 12, 2023
(86) PCT No.: PCT/EP2023/074998

§ 371 Date: Mar. 14, 2025

(30) Foreign Application Priority Data
Sep. 15, 2022 (LU) LU502800

(51) Int. Cl. G01N 29/12; G01B 17/02

(52) U.S. Cl. CPC G01N 29/12; G01B 17/02; G01N 2291/0231; G01N 2291/0258; G01N 2291/02854; G01N 2291/044

(57) ABSTRACT

A method for determining wear of a textured layer affixed to a base layer equipped with an ultrasonic transducer is disclosed, the base layer is interposed between the textured layer and the ultrasonic transducer and the textured layer comprises a recess and a protrusion. The method comprises emitting, by the ultrasonic transducer, an ultrasonic wave towards the recess and the protrusion; receiving, by the ultrasonic transducer, ultrasonic wave echoes of the emitted ultrasonic wave, reflected by the recess and the protrusion of the textured layer; and determining a height difference between the recess and the protrusion based on the received ultrasonic wave echoes. The present invention also relates to a device for determining wear of a textured layer affixed to a base layer and article comprising said device.

### FIELD OF THE INVENTION

The invention generally relates to sensing wear of a textured layer affixed to a base layer with ultrasound waves.

### BACKGROUND OF THE INVENTION

EP 0413119 relates to a centre open large rolling bearing consisting of a single-or multi-piece outer ring and inner ring and rolling elements arranged between them and rolling on tracks, in which one ring is designed to accommodate an ultrasonic probe and the other ring has a coupling surface. One or more revolving coupling surfaces are arranged on one or more outer surfaces of the ring to be tested.

### GENERAL DESCRIPTION

An aspect of the present invention relates to a method for determining wear of a textured layer affixed to a base layer equipped with an ultrasonic transducer. The base layer is interposed between the textured layer and the ultrasonic transducer, the textured layer comprising a recess and a protrusion. The method comprises:
emitting, by the ultrasonic transducer, an ultrasonic wave towards the recess and the protrusion;
receiving, by the ultrasonic transducer, ultrasonic wave echoes of the emitted ultrasonic wave, reflected by the recess and the protrusion of the textured layer; and
determining a height difference between the recess and the protrusion based on the received ultrasonic wave echoes.

It will be appreciated that the present invention allows for mitigating (even cancelling) the effect of the external temperature for determining wear of the textured layer with an ultrasonic transducer. External temperature variations may cause e.g. thermal dilatation of the base layer and/or the transducer. Also, the present invention allows for mitigating (even cancel) issues usually encountered in case of complex interfaces between e.g. the base layer and the textured layer. It will also be appreciated that the present invention allows for measuring wear of the textured layer remotely, in the sense that the ultrasonic transducer need not be directly affixed to the textured layer. The textured layer may be located in an adverse environment so that a transducer affixed on this side may not operate correctly. Consequently, the present invention allows for performing in situ wear measurements even when the textured layer is located in an adverse environment (contamination, wear and/or damage of the transducer is thereby avoided).

The frequency of the emitted ultrasonic wave may be comprised between 20 kHz to 1000 MHz, preferably between 50 kHz to 500 MHz, even more preferably from 100 kHz to 10 MHz.

The ultrasonic transducer may comprise (or consist of) a piezoelectric transducer.

In an embodiment, determining the height difference comprise determining a time difference (i.e. a delay) between echoes reflected by the recess and the protrusion, the determination of the height difference being based on the determined time difference.

Optionally, determining the height difference comprise determining an absorption between echoes reflected by the recess and the protrusion, the determination of the height difference being based on the determined absorption.

In an embodiment, the method further comprises determining a frequency of a resonance peak of the textured layer affixed to the base layer, wherein a frequency of the ultrasonic wave emitted by the ultrasonic transducer is substantially equal to the determined frequency of the resonance peak. The frequency of the emitted ultrasonic wave is preferably comprised within the full width at half maximum (FWHM) of said resonance peak, more preferably within frequencies providing a maximal attenuation of −2 dB with respect to the maximum of the peak, most preferably within frequencies providing a maximal attenuation of −1 dB with respect to the maximum of the peak. Optionally, the determination of the resonance peak comprise sampling the response of the textured layer affixed to the base layer at a plurality of frequencies, for example by emitting a plurality of ultrasonic waves at different frequencies.

The method may comprise determining a phase shift between the ultrasonic wave echoes reflected by the recess and the protrusion of the textured layer. The determination of the height difference between the recess and the protrusion may be based on the determined phase shift.

In an embodiment, the method may further comprise comparing the determined frequency of the resonance peak of the textured layer affixed to the base layer with an expected frequency of the resonance peak, e.g. stored in a database.

The determination of the height difference may comprise mapping the received ultrasonic wave echoes to height difference with a lookup table, a database and/or an artificial intelligence model mapping the received ultrasonic wave echoes to height difference between the recess and the protrusion.

The method may also further comprise communicating the determined height difference to a remote receiver, e.g. by at least one of Bluetooth, Bluetooth Low Energy, Zigbee, Z-Wave, NFC, RFID and 6LoWPAN protocol.

The base layer may comprise a metallic material, such as aluminum, copper, iron, tin, gold, lead, silver, titanium, uranium, and zinc, or any combination thereof. The base layer may comprise a composite material, such as reinforced concrete, fiber-reinforced polymers (for example carbon fiber reinforced polymer, glass-reinforced plastic). The polymer may be a thermoplastic or thermoset. An exemplary thermoset composite material may incorporate aramid fiber and carbon fiber in an epoxy resin matrix. Typically, one of the components of the composite material may be structured, e.g. as a mesh or equivalents. Typical examples of base layer may include stone, steel, PMMA, nylon, alu-dibond (LDPE layer sandwiched between two layers of aluminum).

The textured layer may comprise (or consist of) silicone foam, natural rubber (possibly with polyester inclusion), polychloroprene (neoprene), polyurethane, acrylic, alkyd enamel, acrylonitrile butadiene styrene (ABS), polyoxymethylene (POM/acetal), fluoropolymer (PTFE, PFA, PVDF, FEP, ETFE), polysulfone (PAS, PPS/PPSU, PES, PSU, PSF), polyetherimide (PEI), polyaryle ether ketones (PAEK), polyamide-imide (PAI), polyimide (PI), inorganic enamels and ceramics and the combination as a mixture or as separate phases of the aforementioned layer materials.

An angle of incidence of the emitted ultrasonic wave may be substantially normal to a surface of at least one of the recess and the protrusion. Preferably the angle of incidence may not deviate from more than 10° from the normal incidence, more preferably 5° from the normal incidence, even more preferably 2° from normal incidence.

The emitted ultrasonic wave may be a pulsed ultrasonic wave. Alternatively, the emitted ultrasonic wave may be a continuous ultrasonic wave. Of course, the ultrasonic transducer may emit pulsed and continuous ultrasonic waves possibly sequentially.

The method may comprise storing a frequency of a resonance peak of the textured layer affixed to the base layer, e.g. in a database, preferably instead of determining the height difference. In an embodiment, a plurality of resonance peaks may be stored.

A further aspect of the present invention relates to a device for determining wear of a textured layer affixed to a base layer. The textured layer comprises a recess and a protrusion. The device comprises:
an ultrasonic transducer configured to emit an ultrasonic wave towards the recess and the protrusion and to receive ultrasonic wave echoes of the emitted ultrasonic wave, reflected by the recess and the protrusion of the textured layer;
a controller configured for determining a height difference between the recess and the protrusion based on the received ultrasonic wave echoes.

Determining the height difference may comprise determining a time difference between echoes reflected by the recess and the protrusion, the determination of the height difference being based on the determined time difference.

Determining the height difference may comprise determining an absorption between echoes reflected by the recess and the protrusion, the determination of the height difference being based on the determined absorption.

In an embodiment, the controller is operatively connected to the ultrasonic transducer, the controller being configured for determining a frequency of a resonance peak of the textured layer affixed to the base layer. The controller may be configured for operating the ultrasonic transducer to emit the ultrasonic wave at frequency substantially equal to the determined frequency of the resonance peak. The frequency of the emitted ultrasonic wave is preferably comprised within the full width at half maximum (FWHM) of said resonance peak, more preferably within frequencies providing a maximal attenuation of −2 dB with respect to the maximum of the peak, most preferably within frequencies providing a maximal attenuation of −1 dB with respect to the maximum of the peak.

The controller may further be configured for determining a phase shift between the ultrasonic wave echoes reflected by the recess and the protrusion of the textured layer. The determination of the height difference between the recess and the protrusion may be based on the determined phase shift.

The controller may be configured to compare the determined frequency of the resonance peak of the textured layer affixed to the base layer with an expected frequency of the resonance peak, e.g. stored in a database.

Determining the height difference may comprise mapping the received ultrasonic wave echoes to height difference with a lookup table, a database and/or an artificial intelligence model mapping the received ultrasonic wave echoes to height difference between the recess and the protrusion. The mapping may be carried out by the controller.

A weight of the device may be comprised in the interval from 1 g to 10 g, preferably in an interval from in the interval from 2 g to 9 g, most preferably in the interval from 3 g to 7 g.

The device may further comprise a transmitter selected in the group consisting of a Bluetooth transmitter, a Bluetooth Low Energy transmitter, a Zigbee transmitter, a Z-Wave transmitter, a NFC transmitter, a RFID transmitter and a 6LoWPAN transmitter, the transmitter being configured for communicating the determined height difference to a remote receiver. The transmitter may be controlled by the controller, so that the controller may operate the transmitter for communicating the determined height difference to a remote receiver. In an embodiment, the controller may determine whether the determined height difference is lower or greater than a threshold. Should the determined height difference be lower than the threshold, the controller may operate the transmitted to emit an alarm signal in addition or alternatively to the determined height difference.

The controller may be configured to store the frequency of the resonance peak of the textured layer affixed to the base layer, e.g. in a database, preferably instead of determining the height difference.

An additional aspect of the invention relates to an article comprising a device as disclosed herein. The article comprises a textured layer and a base layer, the textured layer being affixed to the base layer, the base layer being interposed between the textured layer and the ultrasonic transducer of said device, the textured layer comprising a recess and a protrusion.

The ultrasonic transducer may be embedded in the base layer.

In the present document, the verb “to comprise” and the expression “to be comprised of” are used as open transitional phrases meaning “to include” or “to consist at least of”. Unless otherwise implied by context, the use of singular word form is intended to encompass the plural, except when the cardinal number “one” is used: “one” herein means “exactly one”. Ordinal numbers (“first”, “second”, etc.) are used herein to differentiate between different instances of a generic object; no particular order, importance or hierarchy is intended to be implied by the use of these expressions. Furthermore, when plural instances of an object are referred to by ordinal numbers, this does not necessarily mean that no other instances of that object are present (unless this follows clearly from context). When reference is made to “an embodiment”, “one embodiment”, “embodiments”, etc., this means that these embodiments may be combined with one another. An embodiment may relate to the various aspects of the invention unless it is clear from context that it is incompatible with a specific aspect. Furthermore, the features of the embodiments can be used in the combination explicitly presented but also that the features can be combined across embodiments without departing from the invention, unless it follows from context that features cannot be combined.

### BRIEF DESCRIPTION OF THE DRAWINGS

By way of example, preferred, non-limiting embodiments of the invention will now be described in detail with reference to the accompanying drawings, in which:

FIG. 1: shows a simplified view of an article according to an aspect of the present invention;

FIG. 2: shows a typical response of the base layer affixed to the texture layer to an ultrasonic excitation;

FIG. 3: shows plots a typical response of the base layer affixed to the texture layer to ultrasonic excitations;

FIG. 4: shows a typical response of the base layer affixed to the texture layer to ultrasonic excitations;

FIG. 5: shows a typical response of the base layer affixed to the texture layer to ultrasonic excitations; and

FIG. 6: shows a typical response of the base layer affixed to the texture layer to ultrasonic excitations.

The reader's attention is drawn to the fact that the drawings are not to scale. Furthermore, for the sake of clarity, proportions between height, length and/or width may not have been represented correctly.

### DETAILED DESCRIPTION OF PREFERRED EMBODIMENTS OF THE INVENTION

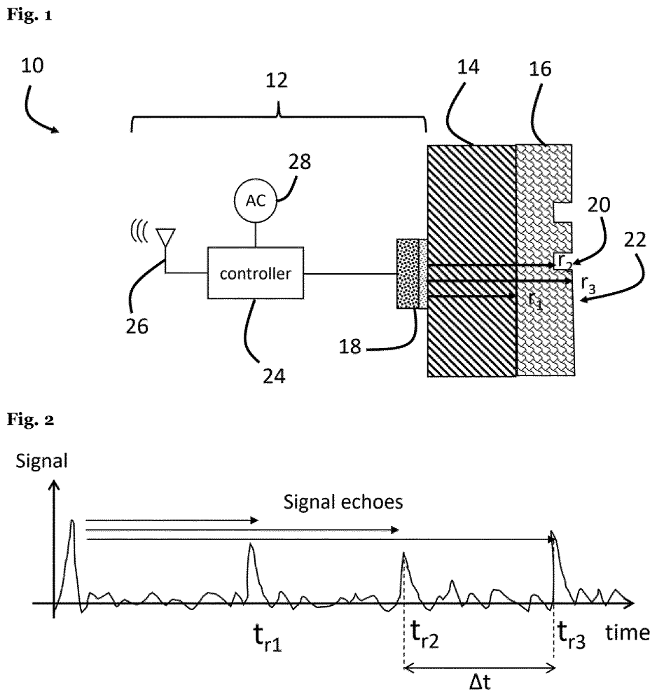

FIG. 1 shows an article 10 comprising a device 12, a base layer 14 and a textured layer 16. The textured layer 16 is affixed to the base layer 14, e.g. by an adhesive, by gluing, by laminating or the like. The textured layer 16 can also be obtained by etching, or in other words by machining, the base layer 14.

On the side opposite to the textured layer 16, the device 12 is provided. The device 12 comprises an ultrasonic transducer 18 (e.g. a piezoelectric transducer), that is in direct contact with the base layer 14. In other words, the base layer 14 is interposed between the textured layer 16 and the ultrasonic transducer 18 of the device 12. In an embodiment, the ultrasonic transducer 18, or even the entire device 12, may be (at least partially, or entirely) embedded in the base layers 14. The ultrasonic transducer 18 may be affixed to the base layer 14 e.g. by an adhesive, by gluing or the like.

The textured layer 16 comprises a recess 20 and a protrusion 22 on its surface, on the side opposite to the base layer 14.

The base layer 14 may comprise a metallic material, such as aluminum, copper, iron, tin, gold, lead, silver, titanium, uranium, and zinc, or any combination thereof. The base layer 14 may comprise a composite material, such as reinforced concrete, fiber-reinforced polymers (for example carbon fiber reinforced polymer, glass-reinforced plastic). The polymer may be a thermoplastic or thermoset. An exemplary thermoset composite material may incorporate aramid fiber and carbon fiber in an epoxy resin or in a rubber matrix. Typically, one of the components of the composite material may be structured, e.g. as a mesh or equivalents that may or may not be metallic. Typical examples of base layer may include stone, steel, PMMA, nylon, alu-dibond (LDPE layer sandwiched between two layers of aluminum). The base layer 14 may comprise a plurality of sub-layers.

The textured layer may comprise (or consist of) silicone foam, natural rubber (possibly with polyester inclusion), polychloroprene (neoprene), polyurethane, acrylic, alkyd enamel, acrylonitrile butadiene styrene (ABS), polyoxymethylene (POM/acetal), fluoropolymer (PTFE, PFA, PVDF, FEP, ETFE), polysulfone (PAS, PPS/PPSU, PES, PSU, PSF), polyetherimide (PEI), polyaryle ether ketones (PAEK), polyamide-imide (PAI), polyimide (PI), inorganic enamels and ceramics and the combination as a mixture or as separate phases of the aforementioned layer materials.

In an embodiment, the composition of the base layer 14 is different from the composition of the textured layer 16.

The ultrasonic transducer 18 is controlled by a controller 24. The ultrasonic transducer 18 may emit, when operated by the controller 24, one or more ultrasonic waves, directed to the textured layer 16 and the base layer 14. The one or more ultrasonic waves may be pulsed or continuous or a combination thereof. In particular, the ultrasonic transducer 18 may emit one or more ultrasonic waves towards the recess 20 and the protrusion 22.

The one or more ultrasonic waves propagate in the base layer 14 and textured layer 16. The one or more ultrasonic waves may then be reflected by interfaces e.g. by an interface between the base layer 14 and the texture layer 16, thereby producing a first reflected wave r₁. The one or more ultrasonic waves may also be reflected by an interface between the texture layer 16 and the medium in which the texture layer is, thereby producing a further reflected waves r₂ and r₃. The reflected waves r₁, r₂ and r₃ may then be received by the ultrasonic transducer 18.

The reflected waves received by the transducer are echoes of the emitted one or more ultrasonic waves, reflected by interfaces as disclosed above.

The received waves may then be processed by the controller 24 for determining, e.g. a height difference between the recess 20 and the protrusion 22 based, for example, on a time difference (delay) At of reception of ultrasonic wave echoes and/or an absorption of the echoes of the emitted ultrasonic wave. Typical height difference may be comprised in the interval from 0.01 mm to 30 mm, preferably in the interval from 0.1 mm to 5 mm, most preferably in the interval from 0.2 mm to 3 mm.

The device may further comprise a transmitter 26 selected in the group consisting of a Bluetooth transmitter, a Bluetooth Low Energy transmitter, a Zigbee transmitter, a Z-Wave transmitter, a NFC transmitter, a RFID transmitter and a 6LoWPAN transmitter. The transmitter may be configured for communicating to a remote receiver e.g. the determined height difference and/or any information provided by the controller such as the position of one or more resonance peaks or the like. The controller may be configured to operate the transmitter 26.

The device may also be equipped with a power source (AC) 28 for powering the components of the device. The controller 24 may be configured to act as a power management system for the device 12, thereby powering e.g. the ultrasonic transducer 18, the transmitter 26 or any other component through the power source (AC) 28.

The controller may operate the device by specific programming or by being specially designed hardware, e.g. an application-specific integrated circuit (ASIC), a digital signal processor (DSP) or a programmable logic circuit (e.g. a FPGA). The controller may comprise a memory or has access to a memory for providing a persistence layer.

A weight of the device may be comprised in the interval from 1 g to 10 g, preferably in an interval from in the interval from 2 g to 9 g, most preferably in the interval from 3 g to 7 g. A dimension of the device may be comprised in the range from 5 mm to 20 mm, preferably from 6 mm to 15 mm, even more preferably from 8 mm to 10 mm. A thickness of the device may be comprised in the range from 1 mm to 10 mm, preferably from 2 mm to 7 mm, even more preferably from 3 mm to 5 mm. In operation, the device may have a low power consumption, e.g. from 1 mW to 100 mW, preferably from 10 mW to 50 mW, even more preferably from 20 mW to 40 mW.

FIG. 2 shows a typical signal obtained by the ultrasonic transducer when emitting an ultrasonic wave pulse as disclosed hereinabove. Four peaks are detected by the ultrasonic transducer 18. The first one is related to the emitted wave and, with delay in order or reception, the echoes r₁, r₂ and r₃. The time between r₂ and r₃, Δt, provides an indication of the height difference between the recess and the protrusion. The difference in absorption between the two peaks may also provide such an indication of the height difference.

By providing a differential measurement of the textured layer, the present invention allows for mitigating (even cancelling) the effect of the external temperature for determining wear of the textured layer with an ultrasonic transducer. Also, the differential measurement allows for cancelling any complexities arising from the base layer (such as e.g. a complex interface between the base layer and the textured layer). It will also be appreciated that the device according to the present invention allows for in situ probing of the article while being indirect in the sense that there is not direct contact with the textured layer.

In the context of the present document, wear of the textured layer may take many forms such as material loss (thereby reducing the thickness of the same), bumps, impurities, contamination (e.g. an additional layer such as a biofilm), defects (e.g. cracks, corrosion), etc. In other words, wear relates to modifications of the textured layer during use, with respect to the intended, produced, textured layer in the factory.

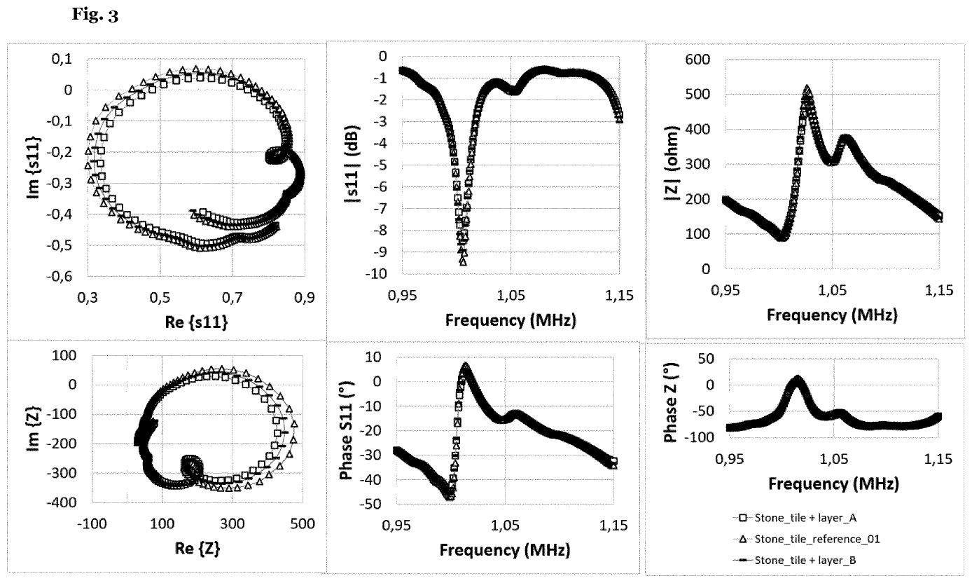

In FIG. 3, an example of measurements that can be obtained by probing the textured layer 16 affixed to the base layer 14 with the device 12. Plotted are:
top left: Nyquist diagram of imaginary part of s₁₁ as a function of real part of s₁₁;
top middle: Bode diagram of modulus of S₁₁ as a function of the emitted ultrasonic wave frequency;
top right: Bode diagram of modulus of Z as a function of the emitted ultrasonic wave frequency;
bottom left: Nyquist diagram of imaginary part of Z as a function of the real part of Z;
bottom middle: Bode diagram of phase of s₁₁ as a function the emitted ultrasonic wave frequency; and
bottom right: Bode diagram of phase of Z as a function the emitted ultrasonic wave frequency.

The modulus of s₁₁ (known as the reflection coefficient) represents reflected power from the textured layer 16 affixed to the base layer 14, while the phase of s₁₁ show a phase shift of the reflected wave with respect to the emitted wave. Z corresponds to the impedance of the ultrasonic transducer and may vary depending on the received ultrasonic wave.

For each of the plots, three samples were probed. The first is a pristine stone tile as a base layer, alone (triangle). The second one is a stone tile with layer A affixed (square) and the third one is a stone tile with layer B affixed (line).

Stone tile is 7 mm thick, layer A is a 3.2 mm thick silicone foam (RS stock No.: 733-6810) and layer B is a 1.5 mm thick natural rubber sheet with polyester insert in its center (RS stock No.: 506-3078). The natural rubber has a density of 1.5 g/cm³.

The plots show a resonance peak at around 1 MHz. The peak provides the better resolution for determining a height difference or absorption.

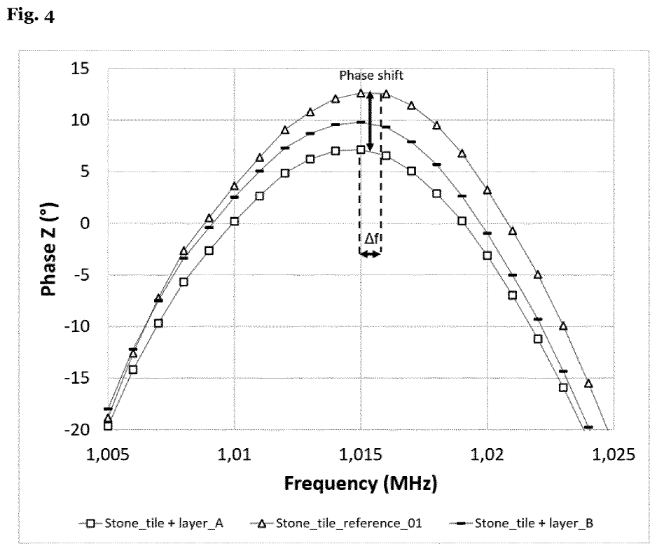

FIG. 4 is a magnification of the bottom right plot of FIG. 3 around a resonance peak. The plot shows a phase difference induced by the thickness difference of the layers (or absence thereof). The phase difference may then be mapped to a height difference, e.g. using a lookup table, a database and/or an artificial intelligence model mapping the same. It should be noted that the phase difference is directly linked to the time difference through the speed of sound in the particular medium.

The lookup table, the database and/or the artificial intelligence model may be locally accessed e.g. the persistence layer is located in the persistent layer of the controller or remotely accessed e.g. through communication from/to the transmitter to a remote server comprising the lookup table, the database and/or the artificial intelligence model.

It is worthwhile noting that a frequency shift Δf of the resonance peak occurs depending on the material affixed to the base layer (layer A or layer B), thereby allowing to determine whether the affixed layer is effectively the one that is expected. This may be particularly advantageous for determining whether a small external object, made of a different material from the base layer 14 and the texture layer 16 is stuck in the recess. Detection of the small external object in the recess may also be an indication that the determined height difference may not be accurate. Also, one or more additional layers may be formed on top of the textured layer during wear, such as e.g. a biofilm. The presence of a biofilm may be detected by the present invention as the resonance peaks may be shifted.

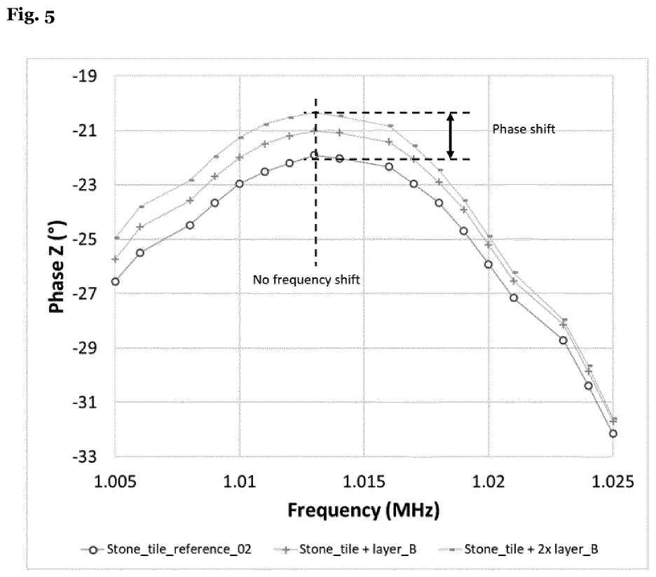

In FIG. 5, three samples were probed. The first is a pristine stone tile as a base layer, alone (circle). The second one is a stone tile with layer B affixed (cross) and the third one is a stone tile with 2 layers B affixed (line).

FIG. 5 show the phase difference imprinted by the difference of thickness of one layer B compared to two times layer B. Here also, the height difference may be determined by the mapping as disclosed above. Also, as expected, no frequency shift occurs.

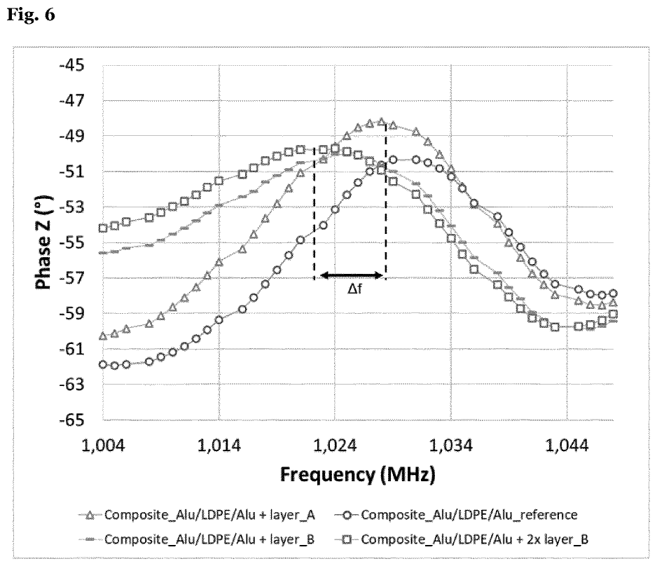

Other materials may also be probed, as shown in FIG. 6. In FIG. 6 an alu-dibond composite (LDPE layer sandwiched between two layers of aluminum) is used as base layer to which either (2×) layer A or layer B is (are) affixed thereon. Here also, a frequency shift may be determined in case another material is detected. In addition a phase shift may also be determined, as previously.

It should be noted that the same analysis may be carried out with other plots such as |s11| as a function of the frequency, |Z| as a function of the frequency, which represent absorption of the emitted wave.

In embodiments, a plurality of transducers may be used. For example a first transducer may be configured to emit an ultrasonic wave towards the recess and a second transducer may be configured to emit an ultrasonic wave towards the protrusion.

The article may be a parquet slat (e.g. wear, loss of protective varnish), a boat hull (e.g. loss of protective paint or addition of biofilm), a fluid delivery pipeline (e.g. corrosion, loss of internal protective coating), a stone brick of a wall (e.g. loss of paint or protective coating), a glass window (e.g. loss of protective infrared or UV coating), a swimming pool liner or synthetic wall (e.g. loss of protective rubber coating) with the advantage that the device 12 is protected and never exposed to the harsh environment.

While specific embodiments have been described herein in detail, those skilled in the art will appreciate that various modifications and alternatives to those details could be developed in light of the overall teachings of the disclosure. Accordingly, the particular arrangements disclosed are meant to be illustrative only and not limiting as to the scope of the invention, which is to be given the full breadth of the appended claims and any and all equivalents thereof.

1. A method for determining wear of a textured layer affixed to a base layer equipped with an ultrasonic transducer, the base layer being interposed between the textured layer and the ultrasonic transducer, the textured layer comprising a recess and a protrusion, the method comprising:
emitting, by the ultrasonic transducer, an ultrasonic wave towards the recess and the protrusion;
receiving, by the ultrasonic transducer, ultrasonic wave echoes of the emitted ultrasonic wave, reflected by the recess and the protrusion of the textured layer; and
determining a height difference between the recess and the protrusion based on the received ultrasonic wave echoes.

2. The method according to claim 1, wherein determining the height difference comprise determining a time difference between echoes reflected by the recess and the protrusion, the determination of the height difference being based on the determined time difference.

3. The method according to claim 1, wherein determining the height difference comprise determining an absorption between echoes reflected by the recess and the protrusion, the determination of the height difference being based on the determined absorption.

4. The method according to claim 1, comprising determining a frequency of a resonance peak of the textured layer affixed to the base layer, wherein a frequency of the ultrasonic wave emitted by the ultrasonic transducer is substantially equal to the determined frequency of the resonance peak.

5. The method according to claim 1, comprising determining a phase shift between the ultrasonic wave echoes reflected by the recess and the protrusion of the textured layer.

6. The method according to claim 4, comprising comparing the determined frequency of the resonance peak of the textured layer affixed to the base layer with an expected frequency of the resonance peak, e.g. stored in a database.

7. The method according to claim 1, wherein the determination of the height difference comprises mapping the received ultrasonic wave echoes to height difference with at least one of a lookup table, a database and an artificial intelligence model mapping the received ultrasonic wave echoes to height difference between the recess and the protrusion.

8. (canceled)

9. The method according to claim 1, wherein the base layer comprises a metallic material.

10. The method according to claim 1, wherein an angle of incidence of the emitted ultrasonic wave is normal to a surface of at least one of the recess and the protrusion.

11. The method according to claim 1, wherein the emitted ultrasonic wave is a pulsed ultrasonic wave.

12. The method according to claim 1, comprising storing a frequency of a resonance peak of the textured layer affixed to the base layer, e.g. in a database.

13. A device for determining wear of a textured layer affixed to a base layer, the textured layer comprising a recess and a protrusion, the device comprising:
an ultrasonic transducer configured to emit an ultrasonic wave towards the recess and the protrusion and to receive ultrasonic wave echoes of the emitted ultrasonic wave, reflected by the recess and the protrusion of the textured layer; and
a controller configured for determining a height difference between the recess and the protrusion based on the received ultrasonic wave echoes.

14. The device according to claim 13, wherein determining the height difference comprise determining a time difference between echoes reflected by the recess and the protrusion, the determination of the height difference being based on the determined time difference.

15. The device according claim 13, wherein determining the height difference comprise determining an absorption between echoes reflected by the recess and the protrusion, the determination of the height difference being based on the determined absorption.

16. The device according to claim 13, wherein the controller is operatively connected to the ultrasonic transducer, the controller being configured for determining a frequency of a resonance peak of the textured layer affixed to the base layer, wherein the controller is configured for operating the ultrasonic transducer to emit the ultrasonic wave at frequency substantially equal to the determined frequency of the resonance peak.

17. The device according to claim 13, wherein the controller is further configured for determining a phase shift between the ultrasonic wave echoes reflected by the recess and the protrusion of the textured layer.

18. The device according to claim 16, the controller being configured to compare the determined frequency of the resonance peak of the textured layer affixed to the base layer with an expected frequency of the resonance peak, e.g. stored in a database.

19. The device according to claim 13, wherein the determination of the height difference comprises mapping the received ultrasonic wave echoes to height difference with at least one of a lookup table, a database and/or an artificial intelligence model mapping the received ultrasonic wave echoes to height difference between the recess and the protrusion.

20. The device according to claim 13, wherein a weight of the device is comprised in the interval from 1 g to 10 g.

21. (canceled)

22. The device according to claim 13, wherein the controller is configured to store the frequency of the resonance peak of the textured layer affixed to the base layer, e.g. in a database, preferably instead of determining the height.

23. (canceled)

24. (canceled)
